(19) United States
(12) Patent Application Publication
(10) Pub. No.: US 2022/0065694 A1
(43) Pub. Date: Mar. 3, 2022

(54) APPLICATION OF LINEAR VARIABLE OPTICAL BANDPASS FILTERS ONTO DETECTOR ARRAYS TO CREATE MOBILE SMART PHONE SPECTROMETERS

(71) Applicant: Salvo Technologies, Inc., Largo, FL (US)

(72) Inventor: Daniel Massey, Clearwater, FL (US)

(21) Appl. No.: 17/392,342

(22) Filed: Aug. 3, 2021

Related U.S. Application Data
(60) Provisional application No. 63/071,414, filed on Aug. 28, 2020.

(51) Int. Cl. G01J 3/02; G02B 5/28

(52) U.S. Cl. CPC G01J 3/0229; G02B 5/288; G01J 3/0256

(57) ABSTRACT

A linear variable optical bandpass filter that is coated directly on an electronic device such as the detector array in a mobile smart phone by a combination of established optical modeling software and microlithography techniques to create a spectrometer in a mobile smart phone is disclosed.

### CROSS-REFERENCE TO RELATED APPLICATION

The present application claims the benefit of previously filed co-pending Provisional Patent Application Ser. No. 63/071,414 filed on Aug. 28, 2020.

### FIELD OF THE INVENTION

The method of this disclosure belongs to the field of spectrometry. More specifically it is the application of a linear variable optical bandpass filter onto an active electronic device such as the detector array in a mobile smart phone.

### BACKGROUND OF THE INVENTION

Over the last decade spectroscopy has increasingly developed to an indispensable analytical tool for production and quality control in various industries. Qualitative spectroscopy investigations are frequently applied in the identity control of incoming raw materials, whereas quantitative analysis of the final product is an important step in the manufacturing process chain. However, the majority of product analyses is still performed by taking a sample from the production site and transporting it to a remote quality control laboratory. This delay between sampling and availability of results limits the frequency of analysis and the optimization of the production line. Thus, novel portable spectroscopy field instrumentation capable of performing a rapid at-line or in-line analysis of the process can be considered as a key tool to advance the effectiveness of various industries.

Older versions of compact spectrometers, such as the ones disclosed in U.S. Patent Publication No. 2012/0188541, published Jul. 26, 2012 to Ocean Optics, Inc., and U.S. Patent Publication No. 2005/0007596, published Jan. 13, 2005 in the name of Wilks Enterprise, Inc., attempt to minimize their footprint by providing a series of optical path folding mirrors. Unfortunately, folding mirrors require extensive alignment procedures during manufacture, and do not provide a very robust structure for field-use devices resulting in low or unpredictable performance.

Several prior art publications have disclosed the concept of spectrometers incorporated on mobile phones such as U.S. Patent Publication No. 2014/0293091 titled Sensor-Synchronized Spectrally-Structured-Light Imaging assigned to Digimarc Corporation that operates by pulsing different LED light sources as different image frames are captured by the phone's CMOS image sensor, and U.S. Patent Publication No. 2014/0061486 titled Spectrometer Devices assigned to Massachusetts Institute of Technology wherein the spectrometer includes a plurality of semiconductor nanocrystals and can be incorporated into a mobile phone. But these, nor any other of the prior art known to Applicant, use the method described in this disclosure to implement the spectrometer in the mobile phone.

Also, U.S. Pat. No. 9,234,839 assigned to JDS Uniphase Corporation discloses a Linear Variable Filter bonded to a detector array as part of a portable spectrometer, but this patent does not disclose the method of attachment or use with a mobile smart phone of this disclosure.

The improved spectrometer using a Linear Variable Filter (LVF) deposited on the detector array of a mobile phone as shown in this disclosure allows for people to write mobile smart phone applications based on spectroscopy methods and software programs already established for prior art spectrometers such as those discussed above.

### BRIEF SUMMARY OF THE INVENTION

A linear variable optical bandpass filter is coated directly on an electronic device such as the detector array in a mobile phone by a combination of established optical modeling software and microlithography techniques to create a spectrometer in a mobile smart phone.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a general concept diagram of the application process of this disclosure; and,

FIG. 2 shows a preferred embodiment diagram of the 3D printed shadow mask method of this disclosure.

### DESCRIPTION OF THE PREFERRED EMBODIMENT

Basically a linear variable optical bandpass filter is coated directly on a detector array of a mobile smart phone by the combination of established optical modeling software and microlithography techniques. More specifically, first the X and Y coordinates of the photosensitive areas of detector array wafer are determined from the top metal structure of the detector array and then these X and Y coordinates, in conjunction with desired linear variable optical bandpass coating dispersion across the photosensitive areas of the detector array are fed into optical modeling software where the coating source is treated as a light source.

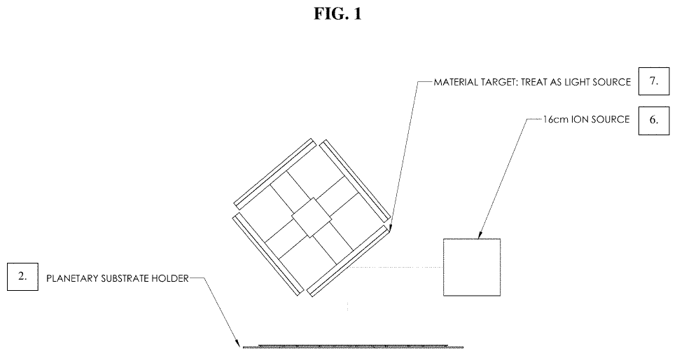

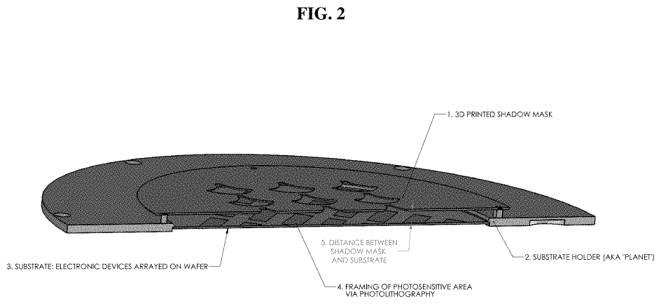

More specifically the output of the optical modeling software mentioned above is a shadow mask (1) design which then is manufactured via 3D printing. Then using an ion source (6) that bombards a linear variable optical bandpass film gradient coating material (7) that is deposited on a substrate (3) held by a planetary substrate holder (2) as shown in FIGS. 1 and 2 such that the linear variable optical bandpass film coating material (7) dispersion on the substrate (3) on each photosensitive area on the detector array (4) is uniform after coating. The material (7) target is treated as a light source where the “rays” of the light are distributed by the beam incident from the 16 cm source (6). The shadow mask (1) has a spacer topography (5) incorporated such that the shadow mask (1) is contacted to the detector array (4) and provides the shadow for the linear variable optical bandpass film coating (7) gradient to be deposited on the detector array (4). Thus, the shadow mask (1) is not printed directly on the detector array (4) but the shadow mask (1) is used only to deposit the linear variable optical bandpass spectral gradient film coating (7) directly on the mobile smart phone detector array.

The detector array shadow mask wafer (1, 3, and 4) is patterned via photolithography techniques in order to create a frame around the photosensitive areas of the detector array (4), allowing for clean coating edges while preventing extraneous linear variable optical bandpass spectral gradient film coating (7) in undesired locations. A patterned photoresist layer can be used to lift-off the edges of the linear variable optical bandpass spectral gradient film coating (7) so as to frame it on the detector array (4).

Finally, using the above-described method the linear variable optical bandpass spectral gradient film coating (7) is deposited directly on the detector array (4), which is then inserted into the mobile smart phone (not shown) creating a spectrometer on the mobile smart phone that can use applications developed for previous spectrometers.

Since certain changes may be made in the above-described method of a linear variable optical bandpass filter coated directly on an electronic device such as the detector array to create a spectrometer in a mobile smart phone without departing from the scope of the invention herein involved, it is intended that all matter contained in the description thereof shall be interpreted as illustrative and not in a limiting sense.

What is claimed is:

1. A method for applying is linear variable optical bandpass filter coating directly on a mobile smart phone detector array comprising:
first X and Y coordinates of photosensitive areas of said mobile smart phone detector array wafer are determined from a top metal structure of said mobile smart phone detector array; and,
then said X and Y coordinates combined with a desired linear variable optical bandpass coating dispersion across said photosensitive areas of said mobile smart phone detector array are fed into an optical modeling software program using a coating application source as a light source.

2. The method of claim 1 wherein an output of said optical modeling software is a shadow mask design and wherein a shadow mask is then manufactured via three-dimensional printing.

3. The method of claim 2 wherein said shadow mask design has a spacer topography incorporated such that said shadow mask is contacted to said mobile smart phone detector array and provides a shadow for said linear variable optical bandpass film coating gradient to be deposited directly on said mobile smart phone detector array.
